(19) United States
(12) Patent Application Publication
(10) Pub. No.: US 2020/0032691 A1
(43) Pub. Date: Jan. 30, 2020

(54) EXHAUST PIPE DEVICE OF SADDLE-RIDING VEHICLE

(71) Applicant: HONDA MOTOR CO., LTD., Tokyo (JP)

(72) Inventor: Katsuki MIURA, Wako-shi (JP)

(73) Assignee: HONDA MOTOR CO., LTD., Tokyo (JP)

(21) Appl. No.: 16/516,947

(22) Filed: Jul. 19, 2019

(30) Foreign Application Priority Data
Jul. 27, 2018 (JP) 2018-141237

(51) Int. Cl. F01N 3/28; F01N 1/00; F01N 13/00; F01N 13/08

(52) U.S. Cl. CPC F01N 3/2885; F01N 1/00; F01N 13/008; B60K 13/04; F01N 13/08; F01N 13/082; F01N 13/007

(57) ABSTRACT

An exhaust pipe device of a saddle-riding vehicle, wherein a power unit is fixed to a body frame of a saddle-riding vehicle, includes an upstream-side exhaust pipe device for discharging exhaust gas from an internal combustion engine, a catalyst built-in pipe connected to a downstream end of the upstream-side exhaust pipe device, and a downstream-side exhaust pipe device connected to a downstream end of the catalyst built-in pipe. An exhaust muffler is connected to a downstream end of the downstream-side exhaust pipe device. The downstream-side exhaust pipe device has a main pipe portion and a branch pipe portion on a downstream side of an upstream end thereof where a branching portion is provided. An exhaust control valve is provided to the branching portion where the branch pipe portion is branched from the main pipe portion. The branch pipe portion overlaps, as seen in side view, with a vehicle center-side wall of the main pipe portion, and downstream ends of both the main and branch pipe portions are connected to the exhaust muffler. The above arrangement provides an exhaust pipe device wherein a branch pipe portion can be formed in a compact shape as viewed in side view, whereby excellent external appearance property is obtained, and a valve shaft of the exhaust control valve at the branching portion can be easily arranged with a required banking angle.

### TECHNICAL FIELD

The present invention relates to an exhaust pipe device of a saddle-riding vehicle where a power unit including an internal combustion engine is fixed to a vehicle body frame.

### BACKGROUND ART

In saddle-riding vehicles where a power unit including an internal combustion engine is fixed to a vehicle body frame, there has been known a saddle-riding vehicle where an exhaust pipe device is branched at an upstream portion of an exhaust muffler and branched exhaust pipe devices are lead to the exhaust muffler. For example, such a saddle-riding vehicle is disclosed in the following Patent Document 1. In the saddle-riding vehicle described in Patent Document 1, the exhaust pipe device has pipes which include a branch pipe branching and extending from a main pipe in vertically spaced-apart disposition. In a case where the flow of exhaust gas is adjusted by an exhaust control valve in the branch pipe of the exhaust pipe device, the exhaust control valve must expand in size in the vehicle width direction, thus giving rise to a drawback with respect to external appearance property. Further, the axis of a rotary shaft of the exhaust control valve must be arranged in a direction perpendicular to a plane of the arrangement of the main and branching pipes of the exhaust pipe device. Accordingly, when the exhaust pipe device includes main and branch pipes included in a vertical plane, the axis of the exhaust control valve must be arranged in a vehicle width direction, thus giving rise to a drawback with respect to the arrangement of the rotary shaft of the valve within a banking angle of the vehicle.

### PRIOR ART DOCUMENT

### Patent Document

[Patent Document 1] JP 2017-057789 A (FIGS. 1 and 2)

### SUMMARY OF INVENTION

### Underlying Problem to be Solved by the Invention

The present invention has been made in view of the above-mentioned prior art, and it is an object of the present invention to provide an exhaust pipe device of a saddle-riding vehicle where a power unit including an internal combustion engine is fixed to a vehicle body frame, wherein even in a case where the exhaust pipe device includes a branch pipe upstream of an exhaust muffler and the branch pipe is lead to the exhaust muffler, a branch portion is formed in a compact shape as viewed in side view so that excellent external appearance property is obtained, and, further, the valve shaft of the exhaust control valve at the branching portion can be easily arranged within a banking angle.

### Means to Solve the Underlying Problem

To overcome the above-described drawbacks, according to the present invention, there is provided an exhaust pipe device of a saddle-riding vehicle wherein a power unit including an internal combustion engine is fixed to a body frame of a saddle-riding vehicle, the exhaust pipe device including an upstream-side exhaust pipe device having an upstream end thereof connected to the internal combustion engine to discharge an exhaust gas, a catalyst built-in pipe connected to a downstream end of the upstream-side exhaust pipe device, and a downstream-side exhaust pipe device having an upstream end thereof connected to a downstream end of the catalyst built-in pipe, and an exhaust muffler is connected to a downstream end of the downstream-side exhaust pipe device,

wherein the downstream-side exhaust pipe device includes a main pipe portion and a branch pipe portion led from a branching portion provided at the upstream end of the downstream-side exhaust pipe device, and an exhaust control valve is provided to the branching portion, and wherein, at the branching portion, the branch pipe portion overlaps with a vehicle center-side wall of the main pipe portion, as seen in side view, and both the main pipe portion and the branch pipe portion have downstream ends thereof connected to an upstream end of the exhaust muffler.

According to the exhaust pipe device of the saddle-riding vehicle of the present invention, the branch pipe portion overlaps with the vehicle center-side wall of the main pipe portion as viewed in side view at the branch portion, and hence the branch portion is formed in a compact shape as viewed in side view, thus improving external appearance property of the saddle-riding vehicle, and the branch pipe portion at the branching portion can be protected by the main pipe portion.

The flow of exhaust gas which flows into the exhaust muffler after passing through the main pipe portion and the branch pipe portion can be changed by the exhaust control valve, and it is possible to prevent a valve shaft of the exhaust control valve at the branch portion from being directed in a vehicle width direction so that the valve shaft can be easily arranged within a banking angle.

According to a preferred embodiment of the present invention, the main pipe portion and the branch pipe portion are disposed such that the downstream ends of the main pipe portion and the branch pipe portion, which are connected to the exhaust muffler, overlap with each other in a vertical direction.

With such a configuration, a connecting portion between the downstream-side exhaust pipe device and the exhaust muffler, as well as the exhaust muffler, can be arranged in a compact shape in a vehicle width direction.

According to a further preferred embodiment of the present invention, the branching portion is disposed in front of a rear wheel.

With such a configuration, a space formed between the rear wheel and a main frame disposed in front of the rear wheel in the saddle-riding vehicle can be effectively utilized.

According to a still further preferred embodiment of the present invention, the exhaust control valve has a valve drive device which overlaps, as viewed in side view, with a rear suspension link connecting a swing arm to a rear suspension.

With such a configuration, by positioning the valve drive device of the exhaust control valve at the height of the rear suspension link, the height position of the downstream-side exhaust pipe device can be maintained, and hence an increased banking angle can be obtained.

According to a preferred embodiment of the present invention, the downstream-side exhaust pipe device extending from the catalyst built-in pipe to an upstream side of the exhaust muffler is disposed in an inclined manner with respect to a vehicle longitudinal direction.

With such a configuration, the downstream-side exhaust pipe device can be led to the exhaust muffler on an outer side portion of the vehicle, and the length of the downstream-side exhaust pipe device can be increased.

According to another preferred embodiment of the present invention, the downstream-side exhaust pipe device has a bent portion disposed between the catalyst built-in pipe and the branching portion disposed downstream of the catalyst built-in pipe, and the downstream-side exhaust pipe device is disposed such that the downstream-side exhaust pipe device extends in a rearward and oblique upward direction.

With such a configuration, the branching portion is disposed rearward of the relatively slender bent portion of the downstream-side exhaust pipe device, and a height position of the downstream-side exhaust pipe device is maintained, whereby an increased banking angle is obtained.

According to a further preferred embodiment of the present invention, the bent portion of the downstream-side exhaust pipe device overlaps, in bottom plan view, with a rear suspension link which connects the swing arm to the rear suspension.

With such a configuration, the relatively slender bent portion disposed between the catalyst built-in pipe and the branching portion of the downstream-side exhaust pipe device is positioned below the rear suspension link. Accordingly, the height position of the downstream-side exhaust pipe device is maintained, and hence an increased banking angle is obtained.

According to a preferred embodiment of the present invention, an exhaust gas sensor is disposed at the bent portion of the downstream-side exhaust pipe device.

With such a configuration, the exhaust gas sensor for detecting exhaust gas downstream of a catalyst can be mounted by utilizing a space inside the bent portion by avoiding the branching portion of the downstream-side exhaust pipe device.

### Advantageous Effects of the Invention

According to the exhaust pipe device of a saddle-riding vehicle of the present invention, the branch pipe portion overlaps with the vehicle center-side wall of the main pipe portion as viewed in side view at the branching portion, and hence the branch portion is formed in a compact shape as viewed in side view, thus improving external appearance property of the saddle-riding vehicle, and the branch pipe portion from the branching portion can be protected by the main pipe portion.

The flow of an exhaust gas which flows into the exhaust muffler after passing through the main pipe portion and the branch pipe portion can be changed by the exhaust control valve, and it is possible to prevent a valve shaft of the exhaust control valve at the branching portion from being directed in a vehicle width direction so that the valve shaft can be easily arranged within a banking angle.

### BRIEF DESCRIPTION OF DRAWINGS

FIG.1 is a left side view of a motorcycle installed with an exhaust pipe device according to an embodiment of the present invention;

FIG. 2 shows a right side surface of a lower portion of a power unit and an exhaust pipe device of the motorcycle shown in FIG. 1;

FIG. 3 shows a right side surface of the motorcycle, in a range rearward of the view of FIG. 2, from the lower portion of the power unit to a rear wheel, the exhaust pipe device, and an exhaust muffler of the motorcycle;

FIG. 4 is a longitudinal sectional view of the exhaust muffler;

FIG. 5 is a perspective view of a branching portion as viewed in a direction indicated by an arrow V-V in FIGS. 2 and 3;

FIG. 6 is a plan view of the branching portion as viewed in a direction indicated by an arrow VI in FIG. 5; and

FIG. 7 is a bottom plan view of the motorcycle, with an oil pan extending from a crankcase to the rear wheel being removed.

### MODE FOR CARRYING OUT THE INVENTION

With reference to the drawings, an exhaust pipe device of a saddle-riding vehicle according to one embodiment of the present invention will be described.

In the description of this specification and claims, directions of front and rear, left and right, and up and down are directions of a saddle-riding vehicle on which an exhaust pipe device of a saddle-riding vehicle according to this embodiment is mounted. In this embodiment, the saddle-riding vehicle is a two-wheel motorcycle.

In the drawings, an arrow FR indicates a frontward direction of the vehicle, an arrow LH indicates a leftward direction of the vehicle, an arrow RH indicates a rightward direction of the vehicle, and an arrow UP indicates an upward direction of the vehicle respectively.

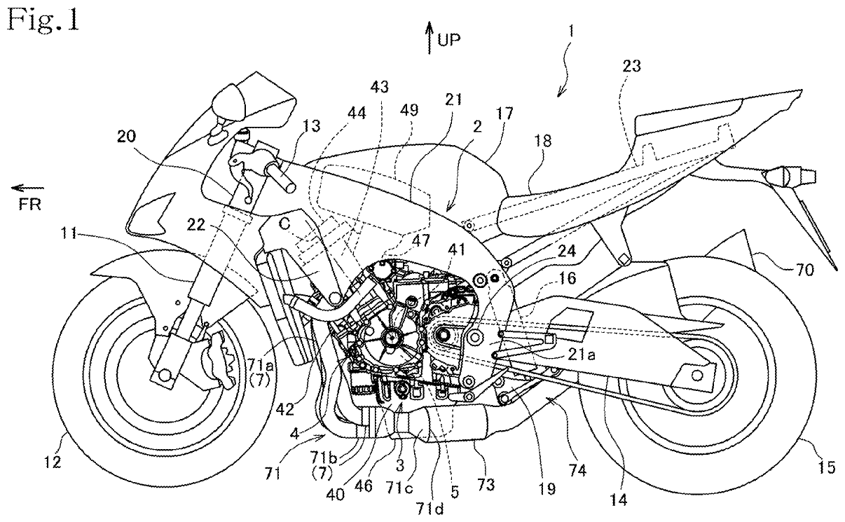

FIG. 1 is a left side view of a two-wheel motorcycle 1 installed with an exhaust pipe device according to this embodiment.

As shown in FIG. 1, a body frame 2 of the motorcycle 1 is formed such that main frames 21 are divided leftward and rightward from a head pipe 20 and extend rearward, and center frame portions 21a of rear portions of the main frames 21 are bent downward.

Down frames 22 extend obliquely from the head pipe 20 in a rearward and downward direction.

Seat rails 23 extend obliquely in a rearward and upward direction from portions of the main frames 21 in front of upper bent portions of the center frame portions 21a.

A front wheel 12 is pivotally supported on lower ends of a front fork 11 which is steerably supported on the head pipe 20, and a handlebar 13 is connected to the front fork 11 by way of an upwardly extending steering shaft (not shown in the drawings).

A swing arm 14 has its front end pivotally supported on a pivot shaft 24 and extends rearward from the center frame portions 21a. A rear wheel 15 is rotatably supported on a rear end of the swing arm 14 which is vertically swingable.

A rear suspension link 19 is disposed between a lower edge of the swing arm 14 and lower end portions of the center frame portions 21a, and a rear suspension 16 is interposed between a part of the rear suspension link 19 and upper portions of the center frame portion 21a.

A power unit 3 including an internal combustion engine 4 is mounted on the motorcycle 1 in a state where the power unit 3 is fixed to the body frame 2. The power unit 3 is configured such that a transmission 5 is housed in a crankcase 40 of the internal combustion engine 4 integrally with the internal combustion engine 4. The power unit 3 is suspended from the down frames 22 disposed on a front side of the main frames 21 and the main frames 21. The internal combustion engine 4 is a water-cooled, serial 4-cylinder, 4-stroke cycle internal combustion engine where four cylinders are arranged in a vehicle width direction, and a crankshaft 41 of the internal combustion engine 4 is directed in the vehicle width direction (lateral direction).

Above the power unit 3, a fuel tank 17 is mounted on the main frames 21 in a bridging manner. A seat 18 is disposed behind the fuel tank 17, and the seat 18 is supported by the seat rails 23.

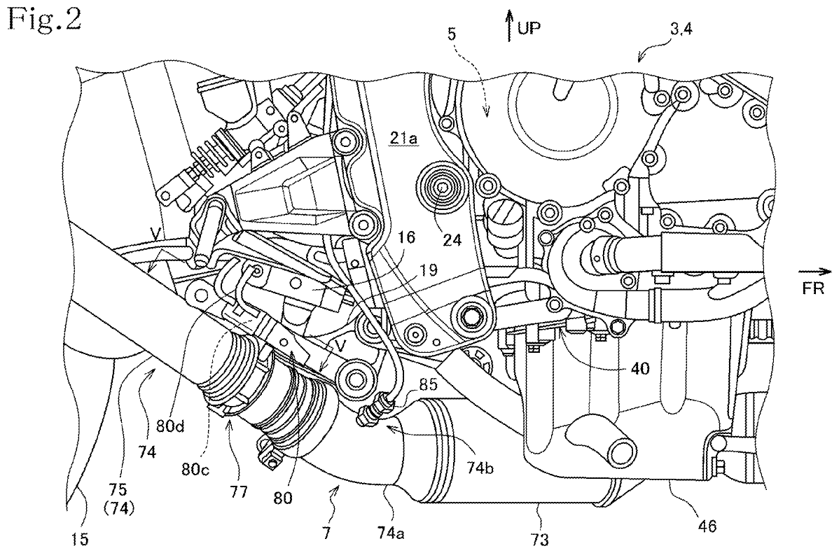

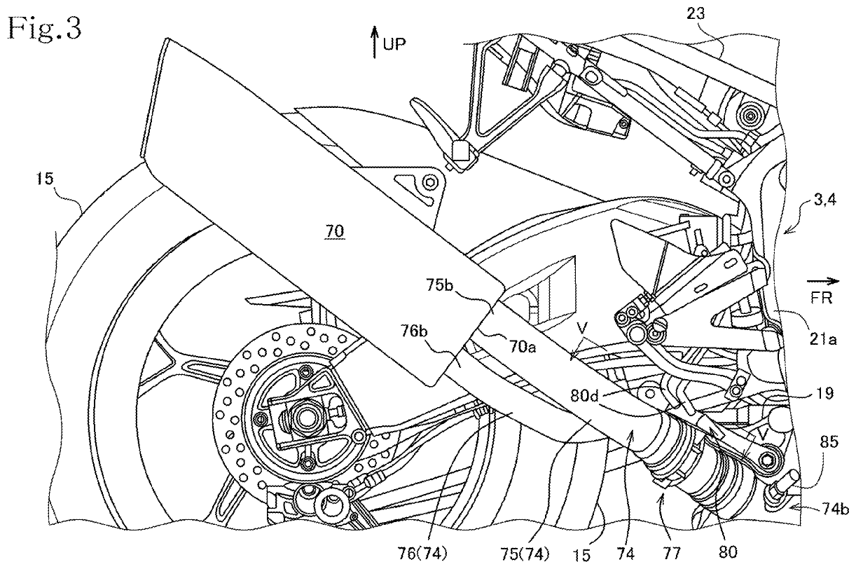

FIG. 2 shows a right side surface of a lower portion of the power unit 3 and an exhaust pipe device 7 of the motorcycle 1. FIG. 3 shows an arrangement rearwardly continuous from the arrangement shown in FIG. 2, and shows a right side surface ranging from a lower portion of the power unit 3 to the rear wheel 15, the exhaust pipe device 7 and an exhaust muffler 70 of the motorcycle 1.

With reference to FIG. 1, a cylinder block 42 and a cylinder head 43 are joined to an upper portion of the crankcase 40, which rotatably supports the crankshaft 41, such that the cylinder block 42 and the cylinder head 43 are sequentially stacked on the crankcase 40 in a raised posture and a cylinder axis C is slightly inclined frontward. The cylinder head 43 is covered by a cylinder head cover 44 from above.

An oil pan 46 is fixed to a lower portion of the crankcase 40.

An intake pipe 47 extends upward from a rear portion of the frontwardly-inclined cylinder head 43 of the internal combustion engine 4, and is connected to an air cleaner 49 by way of a throttle body not shown in the drawings.

The exhaust pipe device 7 extends downward from a front portion of the cylinder head 43, passes a right side of a lower portion of the crankcase 40, extends obliquely upward on a right side of the rear wheel 15, and is connected to the exhaust muffler 70.

As shown in FIG. 1, the exhaust pipe device 7 of this embodiment includes an upstream-side exhaust pipe device 71 and a downstream-side exhaust pipe device 74. The upstream-side exhaust pipe device 71 is made up of: four primary exhaust pipes 71a having upstream ends thereof connected to four exhaust ports formed on a side surface of a front portion of the cylinder head 43 for discharging exhaust gas; unit exhaust pipes 71b formed by merging the four primary exhaust pipes 71a on downstream sides thereof in such a manner that each unit exhaust pipe 71b is connected to two primary exhaust pipes 71a; one exhaust pipe merging portion 71c which is connected to two unit exhaust pipes 71b in common; a catalyst built-in pipe 73, which is continuously connected to a downstream end 71d of the exhaust pipe merging portion 71c, to extend in a direction of extension of the downstream end 71d, and which is disposed below the internal combustion engine 4 in a rearwardly extending manner. The downstream-side exhaust pipe device 74 has its upstream end connected to the catalyst built-in pipe 73, and extends obliquely upward on a right side of the vehicle body, to have a downstream end connected to the exhaust muffler 70.

As shown in FIGS. 2 and 3, the downstream-side exhaust pipe device 74 has a main pipe portion 75 and a branch pipe portion 76 branching from a downstream side of an upstream end 74a of the downstream-side exhaust pipe device 74. The downstream-side exhaust pipe device 74 has a branching portion 77 where the branch pipe portion 76 is branched from the main pipe portion 75.

In the branching portion 77, the branch pipe portion 76 overlaps with a vehicle center-side wall of the main pipe portion 75, as viewed in side view. Downstream ends 75b and 76b (see FIG. 3) of both the main pipe portion 75 and the branch pipe portion 76 are respectively connected to an upstream end 70a of the exhaust muffler 70 which is disposed on a right side of the rear wheel 15.

In this embodiment, the main pipe portion 75 of the downstream-side exhaust pipe device 74 has a structure capable of coping with a high-output time of the internal combustion engine 4, and an exhaust gas is made to flow in the main pipe portion 75 in the high-output time.

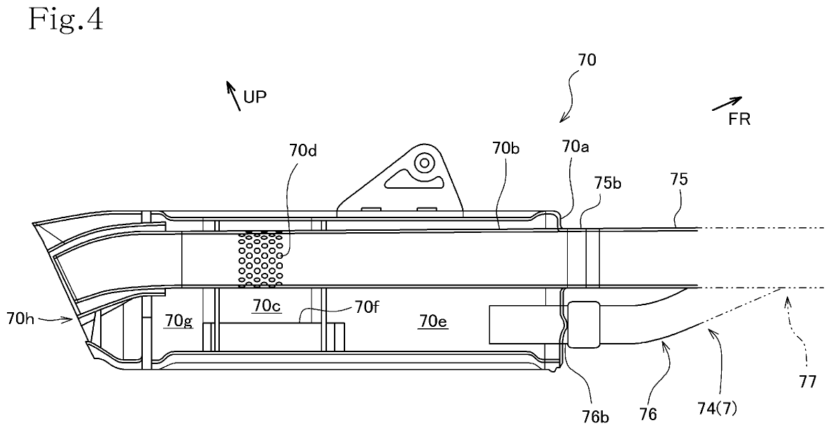

As shown in FIG. 4 illustrating a longitudinal section of the exhaust muffler 70, exhaust gas which flows in the exhaust muffler 70 from the main pipe portion 75 passes through an in-muffler main pipe portion 70b which is connected directly to the main pipe portion 75 in a straight-line shape. In the flow of an exhaust gas flowing through the in-muffler main pipe portion 70b, the exhaust gas flows back and forth in a reciprocating manner between the in-muffler main pipe portion 70b and a second chamber 70c surrounding the in-muffler main pipe portion 70b through a porous portion 70d formed in an intermediate portion of the in-muffler main pipe portion 70b. Accordingly, the exhaust gas can be discharged smoothly without stagnation, thus enhancing an output of the internal combustion engine while acquiring a predetermined muffling effect.

When output of the internal combustion engine 4 is in a middle or low range, exhaust gas is made to flow in the branch pipe portion 76. In the exhaust muffler 70, the exhaust gas first flows and expands in a first chamber 70e, positioned at a most upstream side of the exhaust muffler 70. Thereafter, the exhaust gas expands again in a third chamber 70g, positioned at a downstream-side of the second chamber 70c, flowing through a communication pipe 70f which bypasses the second chamber 70c, thus acquiring a predetermined muffling effect and, thereafter, is discharged through a rear end 70h of the exhaust muffler 70.

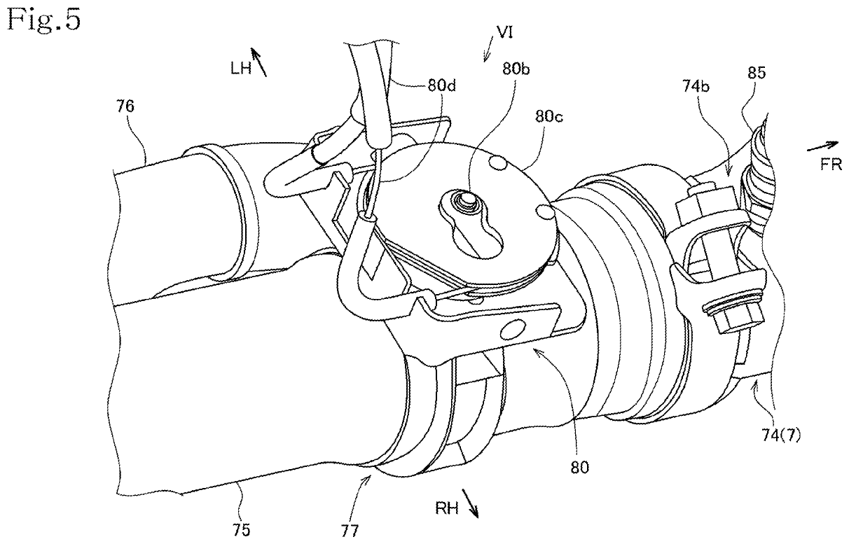

As shown in FIG. 5, which is a perspective view of the branch portion 77 as viewed in a direction indicated by an arrow V-V in FIG. 2, and in FIG. 3, in order to perform such a control of the exhaust gas, the downstream-side exhaust pipe device 74 has an exhaust control valve 80 at the branching portion 77 where the branch pipe portion 76 is branched from the main pipe portion 75 on a downstream side of the upstream end 74a (see FIG. 2) of the downstream side exhaust pipe device 74.

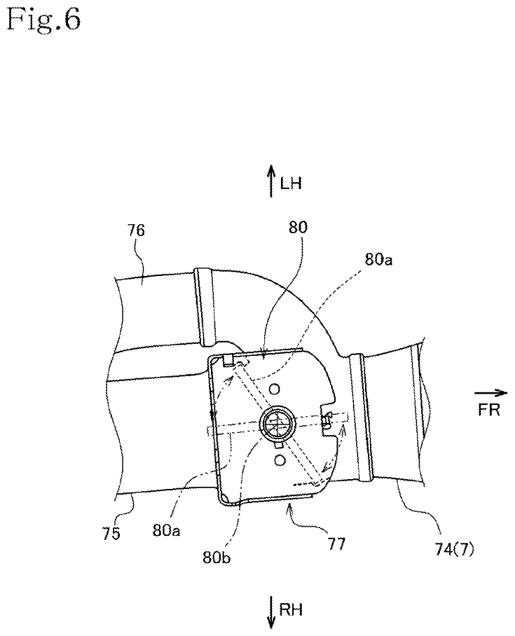

As shown in FIG. 6 which is a plan view of the branching portion 77 as viewed in a direction indicated by an arrow VI in FIG. 5, the branch pipe portion 76 is branched from the main pipe portion 75, in a manner to extend sideward from the branching portion 77. The exhaust control valve 80 is a butterfly valve where a valve plate 80a is disposed so as to be brought into sliding contact with an inner surface of a pipe passage of the branching portion 77.

The exhaust control valve 80 is controlled between a fully-closed position where the valve plate 80a shuts off the flow of exhaust gas into the main pipe portion 75 and guides the whole exhaust gas from an upstream side into the branch pipe portion 76 (in FIG. 6, the valve plate 80a is schematically illustrated by a broken line), and a fully-open position where the valve plate 80a is positioned parallel to the main pipe portion 75 thus allowing introduction of the exhaust gas into the main pipe portion 75 (in FIG. 6, the valve plate 80a is schematically illustrated by a double-dashed chain line).

At the fully-open position, the flow of a part of the exhaust gas into the branch pipe portion 76 is not obstructed.

FIG. 5 shows a valve drive device 80c which is mounted on a valve shaft 80b of the exhaust control valve 80. The valve drive device 80c is a pulley with which a drive wire 80d engages. The drive wire 80d which is driven by a drive motor controlled in accordance with a vehicle control device corresponding to a drive state of the internal combustion engine 4 drives in rotation the valve drive device 80c, thus controlling the position of the valve plate 80a of the exhaust control valve 80.

In this manner, the exhaust control valve 80 is provided to the branch portion 77 of the downstream-side exhaust pipe device 74. Accordingly, by operating the exhaust control valve 80, it is possible to change and control the flow of exhaust gas which passes through the main pipe portion 75 and the branch pipe portion 76 and flows into the exhaust muffler 70.

As shown in FIGS. 2 and 3, the downstream-side exhaust pipe device 74 is inclined in such a manner that the downstream-side exhaust pipe device 74 extends upward toward the rear side from the branching portion 77. However, as shown in the view of the branching portion 77 as seen in a direction indicated by an arrow VI in FIG. 5, the branch pipe portion 76 is branched, at the branching portion 77, leftward from the main pipe portion 75 perpendicular to the valve shaft 80b which is directed in a vertical direction of the exhaust control valve 80.

Accordingly, as will be noted from shown in FIGS. 2 and 3, in the area of the branching portion 77, the branch pipe portion 76 overlaps with a vehicle center-side wall of the main pipe portion 75, with respect to the viewing direction in side view. As a result, the branching portion 77 is formed in a compact shape as viewed in side view, thus improving external appearance property of the saddle-riding vehicle, and the branch pipe portion 76 at the branching portion 77 can be protected by the main pipe portion 75.

It is thus possible to prevent the valve shaft 80b, which is directed in the vertical direction of the exhaust control valve 80 at the branching portion 77, from being directed in the vehicle width direction so that the valve shaft 80b can be easily arranged within a banking angle.

As shown in FIG. 3, the branching portion 77 is disposed in front of the rear wheel 15, and hence a space, formed between the rear wheel 15 and the center frame portion 21a of the main frame 21 disposed in front of the rear wheel 15 of the motorcycle 1, can be utilized effectively.

As will be noted from FIG. 2, in this embodiment, the valve drive device 80c of the exhaust control valve 80 overlaps, as seen in side view, with the rear suspension link 19, which connects the swing arm 14 to the rear suspension 16. Accordingly, by positioning the valve drive device 80c of the exhaust control valve 80 at the height position of the rear suspension link 19, the height position of the downstream-side exhaust pipe device 74 can be maintained and hence an increased banking angle can be obtained.

As shown in FIG. 3, the branch pipe portion 76, branched from the main pipe portion 75 at the branching portion 77, is formed such that the branch pipe portion 76 is routed to be positioned below the main pipe portion 75 and extends in a rearward direction, and is connected to the exhaust muffler 70 parallel to the main pipe portion 75 and below the main pipe portion 75.

In this manner, the main pipe portion 75 and the branch pipe portion 76 are disposed such that the downstream ends 75b and 76b of the main and branch pipe portions 75 and 76 which are connected to the exhaust muffler 70 overlap with each other in the vertical direction. Accordingly, the exhaust muffler 70 and a connecting portion between the downstream-side exhaust pipe device 74 and the exhaust muffler 70 can be arranged in a compact shape in the vehicle width direction.

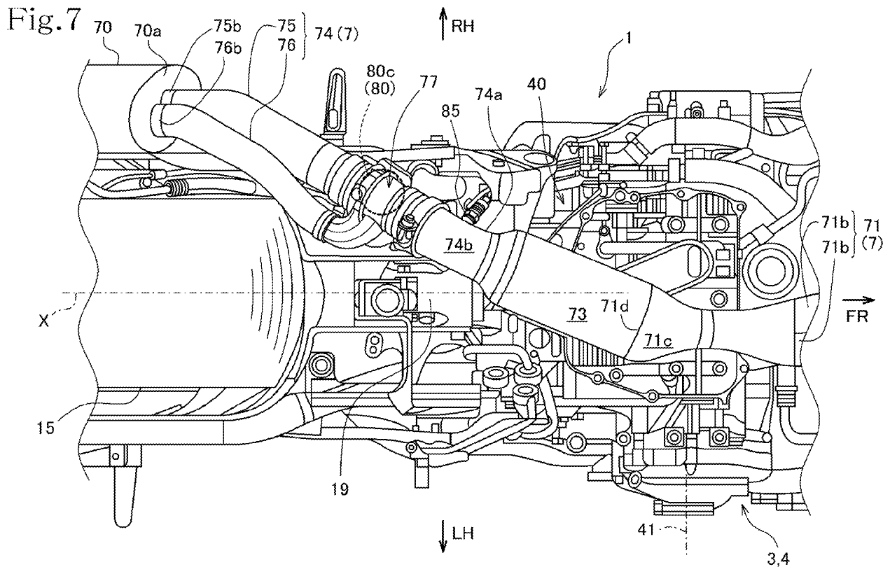

As shown in FIG. 7, which is a bottom plan view of the motorcycle 1 in a state where the oil pan 46 extending from the crankcase 40 toward the rear wheel 15 is removed, two unit exhaust pipes 71b, which are respectively formed by merging the primary exhaust pipes 71a connected to exhaust ports of the respective cylinders to each other, are merged into one pipe at the exhaust pipe merging portion 71c, and are connected to the catalyst built-in pipe 73. The exhaust pipe merging portion 71c and the catalyst built-in pipe 73 are thus arranged to extend along a lower portion of the internal combustion engine 4 and are positioned in an approximately center area in the vehicle width direction.

Meanwhile, the exhaust muffler 70 is disposed on a right side of the rear wheel 15, and hence the downstream-side exhaust pipe device 74 connected to the downstream side of the catalyst built-in pipe 73 is disposed in an obliquely extending manner from an approximately center area in the vehicle width direction to the exhaust muffler 70 on the right side of the rear wheel 15.

That is, the downstream-side exhaust pipe device 74 extending from the catalyst built-in pipe 73 to the upstream side of the exhaust muffler 70 is disposed in an inclined manner with respect to a vehicle longitudinal center axis X extending in the vehicle longitudinal direction, and the downstream-side exhaust pipe device 74 extends to the exhaust muffler 70 located on a laterally outer side of the vehicle, whereby the length of the downstream-side exhaust pipe device 74 can be increased by arranging the downstream-side exhaust pipe device 74 in an inclined manner.

As shown in FIGS. 2 and 3, the downstream-side exhaust pipe device 74 is connected to the catalyst built-in pipe 73 in such a manner that the downstream-side exhaust pipe device 74 is bent obliquely upward from the downstream end of the catalyst built-in pipe 73. That is, the bent portion 74b of the downstream-side exhaust pipe device 74 is disposed downstream of the catalyst built-in pipe 73, and the downstream-side exhaust pipe device 74 is disposed such that the downstream-side exhaust pipe device 74 is directed in a rearward and oblique upward direction. The branching portion 77 is disposed rearward of the relatively slender bent portion 74b compared to the catalyst built-in pipe 73, so that the height position of the downstream-side exhaust pipe device 74 can be maintained and hence an increased banking angle can be obtained.

As shown in FIG. 7, the bent portion 74b of the downstream-side exhaust pipe device 74 disposed downstream of the catalyst built-in pipe 73 and the rear suspension link 19 connecting the swing arm 14 to the rear suspension 16, overlap substantially with each other as viewed in bottom plan view. That is, the relatively slender bent portion 74b disposed between the catalyst built-in pipe 73 and the branching portion 77 of the downstream-side exhaust pipe device 74 is positioned below the rear suspension link 19, and hence the height position of the downstream-side exhaust pipe device 74 can be maintained, to thus make it possible to obtain an increased banking angle.

In this embodiment, as shown in FIGS. 2, 3 and 7, an exhaust gas sensor 85 for detecting a state of exhaust gas which passes through the catalyst built-in pipe 73 is mounted on the bent portion 74b of the downstream-side exhaust pipe device 74 downstream of the catalyst built-in pipe 73. That is, the exhaust gas sensor 85 for detecting state of exhaust gas downstream of a catalyst can be installed by making use of a space created by the bent portion 74b, to thus avoid interference with the branching portion 77 of the downstream-side exhaust pipe device 74.

Although one embodiment of the present invention has been described heretofore, the present invention is not limited to the above-described embodiment, and various modifications are conceivable without departing from the gist of the present invention. For example, the application of the power unit and the internal combustion engine is not limited to a motorcycle, and the power unit and the internal combustion engine are widely applicable to other kinds of saddle-riding vehicle.

For the sake of convenience of the description, the description has been made in accordance with the embodiment shown in the drawings with respect to the arrangement of the constitutional elements with respect to the vehicle lateral direction. However, the arrangement of the constitutional elements is not limited to the embodiment, and may be reversed in the lateral direction.

### REFERENCE SINGS LIST

1: motorcycle
2: body frame
3: power unit
4: internal combustion engine
7: exhaust pipe device
14: swing arm
15: rear wheel
16: rear suspension
19: rear suspension link
21: main frame
21a: center frame portion
40: crankcase
41: crankshaft
42: cylinder block
43: cylinder head
46: oil pan
70: exhaust muffler
70a: upstream end
70b: inner muffler main pipe portion
70c: second chamber
70d: porous portion
70e: first chamber
70f: communication pipe
70g: third chamber
70h: rear end
71: upstream-side exhaust pipe device
71a: primary exhaust pipe
71b: unit exhaust pipes
71c: exhaust pipe merging portion
71d: downstream end
73: catalyst built-in pipe
74: downstream-side exhaust pipe device
74a: upstream end
74b: bent portion
75: main pipe portion
75b: downstream end
76: branch pipe portion
76b: downstream end
77: branching portion
80: exhaust control valve
80a: valve plate
80b: valve shaft
80c: valve drive device
80d: drive wire
85: exhaust gas sensor

1. An exhaust pipe device of a saddle-riding vehicle wherein a power unit including an internal combustion engine is fixed to a body frame of a saddle-riding vehicle, the exhaust pipe device including an upstream-side exhaust pipe device having an upstream end thereof connected to the internal combustion engine to discharge an exhaust gas, a catalyst built-in pipe connected to a downstream end of the upstream-side exhaust pipe device, and a downstream-side exhaust pipe device having an upstream end thereof connected to a downstream end of the catalyst built-in pipe, and an exhaust muffler is connected to a downstream end of the downstream-side exhaust pipe device,
wherein the downstream-side exhaust pipe device includes a main pipe portion and a branch pipe portion led from a branching portion provided at the upstream end of the downstream-side exhaust pipe device, and an exhaust control valve is provided to the branching portion, and wherein, at the branching portion, the branch pipe portion overlaps with a vehicle center-side wall of the main pipe portion, as seen in side view, and both the main pipe portion and the branch pipe portion have downstream ends thereof connected to an upstream end of the exhaust muffler.

2. The exhaust pipe device of a saddle-riding vehicle according to claim 1, wherein the main pipe portion and the branch pipe portion are disposed such that the downstream ends of the main pipe portion and the branch pipe portion, which are connected to the exhaust muffler, overlap with each other in a vertical direction.

3. The exhaust pipe device of a saddle-riding vehicle according to claim 1, wherein the branching portion is disposed in front of a rear wheel.

4. The exhaust pipe device of a saddle-riding vehicle according to claim 1, wherein the exhaust control valve has a valve drive device which overlaps, as viewed in side view, with a rear suspension link connecting a swing arm to a rear suspension.

5. The exhaust pipe device of a saddle-riding vehicle according to claim 1, wherein the downstream-side exhaust pipe device extending from the catalyst built-in pipe to an upstream side of the exhaust muffler is disposed in an inclined manner with respect to a vehicle longitudinal direction.

6. The exhaust pipe device of a saddle-riding vehicle according to claim 1, wherein the downstream-side exhaust pipe device has a bent portion disposed between the catalyst built-in pipe and the branching portion disposed downstream of the catalyst built-in pipe, and the downstream-side exhaust pipe device is disposed such that the downstream-side exhaust pipe device extends in a rearward and oblique upward direction.

7. The exhaust pipe device of a saddle-riding vehicle according to claim 6, wherein the bent portion of the downstream-side exhaust pipe device overlaps, in bottom plan view, with a rear suspension link which connects the swing arm to the rear suspension.

8. The exhaust pipe device of a saddle-riding vehicle according to claim 6, wherein an exhaust gas sensor is disposed at the bent portion of the downstream-side exhaust pipe device.
